(19) United States
(12) Patent Application Publication
(10) Pub. No.: US 2022/0017771 A1
(43) Pub. Date: Jan. 20, 2022

(54) WATER-BASED SURFACE TREATMENT AGENT

(71) Applicant: NAN YA PLASTICS CORPORATION, Taipei (TW)

(72) Inventors: TE-CHAO LIAO, TAIPEI (TW); SEN-HUANG HSU, TAIPEI (TW); CHUNG-CHI SU, TAIPEI (TW)

(21) Appl. No.: 17/335,257

(22) Filed: Jun. 1, 2021

(30) Foreign Application Priority Data
Jul. 15, 2020 (TW) 109123839

(51) Int. Cl. C09D 175/04; C09D 183/04; C09D 7/47; C09D 7/45; C09D 7/43; C09D 7/65; C09D 7/63; D06N 3/14

(52) U.S. Cl. CPC C09D 175/04; C09D 183/04; C09D 7/47; D06N 3/14; C09D 7/43; C09D 7/65; C09D 7/63; C09D 7/45

(57) ABSTRACT

A water-based surface treatment agent is provided. The water-based surface treatment agent is suitable to be coated onto a surface of a synthetic leather. The water-based surface treatment agent at least includes waterborne polyurethane, silicone powder, and water. Based on 100 parts by weight of the water-based surface treatment agent, a content of the waterborne polyurethane is within 15 to 35 parts by weight, and a content of the silicone powder is within 3 to 20 parts by weight. A non-volatile matter content of the waterborne polyurethane is within a range from 20 wt % to 30 wt %. Each grain of the silicone powder has a particle size within a range from 0.2 μm to 15 μm, a specific gravity within a range from 0.9 to 1.5, a water content within a range from 0.1% to 0.5%, and a hardness (A) within a range from 30 to 90.

### CROSS-REFERENCE TO RELATED PATENT APPLICATION

This application claims the benefit of priority to Taiwan Patent Application No. 109123839, filed on Jul. 15, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a surface treatment agent, and more particularly to a water-based surface treatment agent.

### BACKGROUND OF THE DISCLOSURE

In a conventional synthetic leather producing process, inorganic materials such as talcum powder or silicon dioxide or organic materials such as wax or stearic acid are added into a surface treatment agent to enhance an abrasion resistance and a scratch resistance of a dry film. However, adding the inorganic materials such as talcum powder or silicon dioxide reduces a cold and tortuous resistance at low temperature of the dry film, and causes a crease whitening phenomenon over time. Adding the organic materials such as wax or stearic acid affects an adhesion resistance and a gloss effect of the dry film after hot-pressing. Therefore, it is important to further develop the components of the surface treatment agent, so as to increase the abrasion resistance and the scratch resistance of the dry film, while not affecting other properties of the dry film.

In addition, since solvent-based polyurethane is used in the conventional synthetic leather producing process, a large amount of organic waste gas is generated in the process, thereby causing environmental pollutions.

### SUMMARY OF THE DISCLOSURE

In response to the above-referenced technical inadequacies, the present disclosure provides a water-based surface treatment agent.

In one aspect, the present disclosure provides a water-based surface treatment agent. The water-based surface treatment agent is suitable to be coated onto a surface of a synthetic leather, and the water-based surface treatment agent includes waterborne polyurethane, silicone powder, and water. Based on 100 parts by weight of the water-based surface treatment agent, a content range of the waterborne polyurethane is 15 to 35 parts by weight, and a content range of the silicone powder is 3 to 20 parts by weight. A non-volatile matter content of the waterborne polyurethane is within a range from 20 wt % to 30 wt %. Each grain of the silicone powder has a particle size within a range from 0.2 μm to 15 μm, a specific gravity within a range from 0.9 to 1.5, a water content within a range from 0.1% to 0.5%, and a hardness (A) within a range from 30 to 90.

Therefore, since the water-based surface treatment agent includes 20 to 30 parts by weight of waterborne polyurethane, 3 to 30 parts by weight of silicone powder, the non-volatile matter content of the waterborne polyurethane is within a range from 20 wt % to 30 wt %, and each grain of the silicone powder has a particle size within a range from 0.2 μm to 15 μm, a specific gravity within a range from 0.9 to 1.5, a water content within a range from 0.1% to 0.5%, and a hardness (A) within a range from 30 to 90, pollution to the environment can be prevented, the abrasion resistance and the scratch resistance of the dry film formed by the water-based surface treatment agent can be enhanced, and other properties of the dry film are not negatively affected.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view showing a water-based surface treatment agent forming a wet film on a surface of a synthetic leather according to an embodiment of the present disclosure;

FIG. 2 is a schematic view showing the water-based surface treatment agent forming a dry film on the surface of the synthetic leather according to the embodiment of the present disclosure;

FIG. 3 is a flow chart of a method for producing the water-based surface treatment agent of the embodiment of the present disclosure; and

FIG. 4 is a flow chart of a method for implementing the water-based surface treatment agent of the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Water-Based Surface Treatment Agent

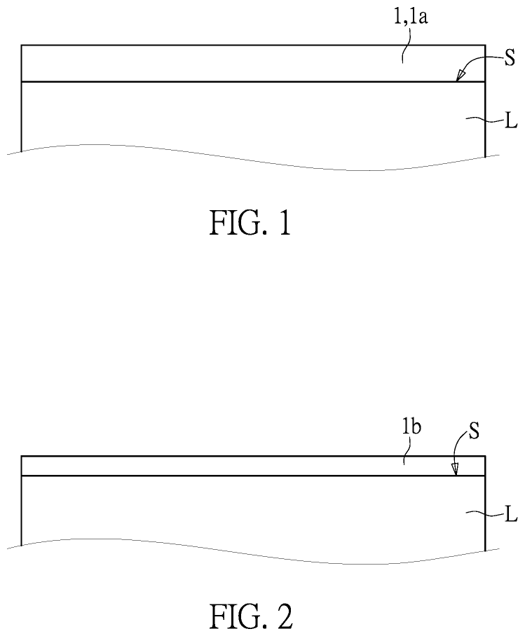

Referring to FIG. 1 and FIG. 2, FIG. 1 is a schematic view showing a water-based surface treatment agent forming a wet film on a surface of a synthetic leather according to an embodiment of the present disclosure, and FIG. 2 is a schematic view showing the water-based surface treatment agent forming a dry film on the surface of the synthetic leather according to the embodiment of the present disclosure. The present embodiment provides a water-based surface treatment agent 1, the water-based surface treatment agent 1 is suitable to be coated onto a surface S of a synthetic leather L, and the water-based surface treatment agent 1 can provide a good scratch resistance and a good abrasion resistance. Naturally, the water-based surface treatment agent 1 can be coated onto a plurality of surfaces (e.g., two surfaces) of the synthetic leather L to provide a better scratch resistance and a better abrasion resistance. The synthetic leather L can be, for example, an automobile interior leather, a clothing leather, or a furniture leather, but the present disclosure is not limited thereto. It is worth mentioning that the water-based surface treatment agent 1 does not have any volatile organic compounds (VOC), so as to achieve zero VOC requirements in the market and avoid pollution to the environment. After the water-based surface treatment agent 1 is coated onto the surface S of the synthetic leather L, the water-based surface treatment agent 1 forms into a wet film 1a on the surface S, and then the wet film 1a forms into a dry film 1b after being dried.

In addition, the water-based surface treatment agent 1 includes waterborne polyurethane, silicone powder, water, an antifoaming agent, a leveling agent, a substrate wetting agent, a dispersant, an organic smoothing agent, a thickener, a matting agent, and a bridging agent. Based on 100 parts by weight of the water-based surface treatment agent 1, a content range of the waterborne polyurethane is 15 to 35 parts by weight, a content range of the silicone powder is 3 to 20 parts by weight, a content range of water is 10 to 70 parts by weight, a content range of the antifoaming agent is 0.2 to 2 parts by weight, a content range of the leveling agent is 0.2 to 5 parts by weight, a content range of the substrate wetting agent is 0.2 to 5 parts by weight, a content range of the dispersant is 0.1 to 2 parts by weight, a content range of the organic smoothing agent is 2 to 10 parts by weight, a content range of the thickener is 1 to 5 parts by weight, a content range of the matting agent is 1 to 5 parts by weight, and a content range of the bridging agent is 2 to 10 parts by weight.

It should be noted that the water-based surface treatment agent 1 does not have any inorganic materials such as talcum powder or silicon dioxide, and does not have organic materials such as wax or stearic acid, so as to prevent the above inorganic materials or the above organic materials from affecting the properties (e.g., a cold and tortuous resistance at low temperature, a crease whitening phenomenon over time, an adhesion resistance, and a gloss) of the dry film 1b formed by the water-based surface treatment agent 1, but the present disclosure is not limited thereto.

A non-volatile matter (NV) content of the waterborne polyurethane is within a range from 20 wt % to 30 wt %. A preferable content range of the waterborne polyurethane is within a range from 17 to 30 parts by weight, and a more preferable content range of the waterborne polyurethane is within a range from 20 to 28 parts by weight. In the present embodiment, the waterborne polyurethane is at least one selected from the group consisting of waterborne flat polyurethane, waterborne matting polyurethane, and waterborne self-matting polyurethane In the present embodiment, the water-based surface treatment agent 1 does not have any solvent-based polyurethane (i.e., polyurethane having organic solution as a solvent), so as to avoid the generation of a large amount of organic waste gas due to using the solvent-based polyurethane. It is worth mentioning that compared to aromatic polyurethane, aliphatic polyurethane and cycloaliphatic polyurethane have a better storage stability and a better yellowing resistance. In other words, the aliphatic polyurethane and the cycloaliphatic polyurethane are more stable and their colors do not easily turn yellow. In the present embodiment, the waterborne polyurethane can be selected from the group consisting of the aliphatic polyurethane and the cycloaliphatic polyurethane and exclude the aromatic polyurethane, so that the waterborne polyurethane can have the better storage stability and better yellowing resistance, but the present disclosure is not limited thereto.

The silicone powder is evenly dispersed in the water-based surface treatment agent 1 and can provide a good scratch resistance and a good abrasion resistance. The silicone powder is shaped in a sphere, and each grain of the silicone powder has a particle size within a range from 0.2 μm to 15 μm, a specific gravity within a range from 0.9 to 1.5, a water content within a range from 0.1% to 0.5%, and a hardness (A) (i.e., Rockwell hardness) within a range from 30 to 90. The silicone powder is at least one selected from the group consisting of silicone composite powder, silicone rubber powder, and silicone resin powder. Based on 100 parts by weight of the water-based surface treatment agent, a preferable content range of the silicone powder is 6 to 13 parts by weight.

According to the abovementioned particle size, the water content, the specific gravity, and the hardness (A) of the silicone powder, the silicone powder can be better and evenly dispersed in the water-based surface treatment agent 1, and can provide a better scratch resistance and a better abrasion resistance. In contrast, if the particle size, the water content, the specific gravity, and the hardness (A) of the silicone powder do not fall within the above-defined ranges, the silicone powder are not conducive to being evenly dispersed in the water-based surface treatment agent 1, and the silicone powder cannot provide the good scratch resistance and the good abrasion resistance.

For example, if the particle size of each of the silicone powder is too great (e.g., greater than 15 μm), the silicone powder are not conducive to being evenly dispersed in the water-based surface treatment agent 1 since the particle size is too great. If the specific gravity of each of the silicone powder is too low, the silicone powder are prone to float above the water-based surface treatment agent 1 and are not conducive to being evenly dispersed since the specific gravity is too low. In contrast, if the specific gravity of the silicone powder is too high (e.g., greater than 1.5 μm), the silicone powder is prone to sink in the water-based surface treatment agent 1 and are not conducive to being evenly dispersed since the specific gravity is too high.

In the present embodiment, the leveling agent is at least one selected from the group consisting of acrylic copolymer and organosilicon compound. Since the water-based surface treatment agent 1 includes the leveling agent, after the wet film 1a is dried to form the dry film 1b, the dry film 1b is relatively flat and smooth. In contrast, if the water-based surface treatment agent 1 does not include the leveling agent, a surface of the dried film 1b formed by the water-based surface treatment agent 1 may be uneven, or the dry film 1b may have a plurality of concavities and a plurality of protrusions at the surface thereof, thereby affecting an usage property of the dry film 1b formed by the water-based surface treatment agent 1.

In the present embodiment, the antifoaming agent is at least one selected from the group consisting of emulsified silicone oil, higher alcohol fatty acid ester complex, polyoxyethylene polyoxypropylene pentaerythritol ether, polyoxyethylene polyoxypropyle, polyoxypropylene glycerol ether, and polyoxypropylene. The antifoaming agent can prevent a plurality of bubbles from forming in the water-based surface treatment agent 1, so as to prevent the bubbles from affecting the dry film 1b. For example, excessive bubbles make it difficult for a preparation process of the water-based surface treatment agent to be smoothly performed, thereby affecting the properties of the water-based surface treatment agent 1.

In the present embodiment, the substrate wetting agent is at least one selected from the group consisting of polyoxyethylene alkylphenol ether, polyoxyethylene fatty alcohol ether, polyoxyethylene polyoxypropylene block copolymer, and silanol non-ionic surfactant. The substrate wetting agent can provide a good wetting effect, and can reduce a critical surface tension between the wet film 1a or the dry film 1b formed by the water-based surface treatment agent 1 and the synthetic leather L. Accordingly, the dry film 1b can be relatively flat and even. In contrast, if the water-based surface treatment agent 1 does not include the substrate wetting agent, the abovementioned critical surface tension can be too great, such that the dry film 1b cannot be flat and even.

The dispersant is at least one selected from the group consisting of acrylic dispersant, modified acrylic dispersant, and modified block polymer. The dispersant enables each component in the water-based surface treatment agent 1 to be more evenly dispersed in the water-based surface treatment agent 1, so as to prevent the water-based surface treatment agent 1 from not providing the good scratch resistance and abrasion resistance since each component is not evenly dispersed in the water-based surface treatment agent.

The thickener is at least one selected from the group consisting of polyacrylic acid thickener and polyurethane associative thickener. The thickener can increase a viscosity of the water-based surface treatment agent 1, so that the viscosity of the water-based surface treatment agent 1 is within a range from 300 cps to 1,000 cps.

The organic smoothing agent is at least one selected from the group consisting of polydialkylsiloxane, modified polysiloxane, branched polyorganosiloxane, polyolefin wax, polyamide wax, polytetrafluoroethene (PTFE), and perfluoroalkoxy resin (PFA). The organic smoothing agent can increase a fluidity of the water-based surface treatment agent 1.

The matting agent is at least one selected from the group consisting of crosslinked styrene-acrylonitrile polymer, crosslinked styrene microspheres, styrene block copolymer, styrene-ethylene-propylene-styrene block copolymer, ethylene propylene diene monomer (EPDM), nitrile rubber, ethylene-octene copolymer, and acrylate rubber. Since the water-based surface treatment agent 1 is added with the matting agent, the dry film 1b on the surface S of the synthetic leather L can provide a matting effect.

The bridging agent is at least one selected from the group consisting of oxazoline, polycarbodiimide, polyisocyanate, blocked isocyanate, polysiloxane, aziridine, and alkylated melamine The bridging agent can provide a bridging effect in the water-based surface treatment agent 1, so as to increase an adhesion, a washing resistance, and the abrasion resistance of the wet film 1a or the dry film 1b formed by the water-based surface treatment agent 1.

### Method for Producing Water-Based Surface Treatment Agent

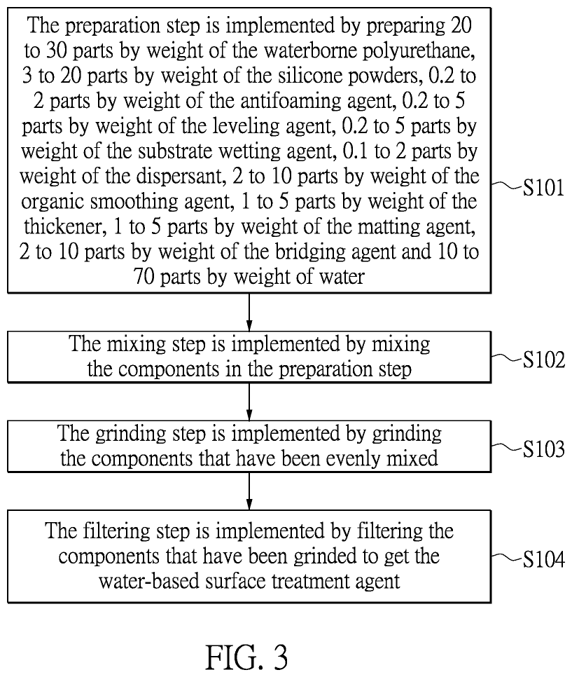

Referring to FIG. 3, FIG. 3 is a flow chart of a method for producing a water-based surface treatment agent of the embodiment of the present disclosure. In the present embodiment, the water-based surface treatment agent 1 can be produced by a preparation step S101, a mixing step S102, a grinding step S103, and a filtering step S104, but the present disclosure is not limited thereto.

The preparation step S101 is implemented by preparing 20 to 30 parts by weight of the waterborne polyurethane, 3 to 20 parts by weight of the silicone powder, 0.2 to 2 parts by weight of the antifoaming agent, 0.2 to 5 parts by weight of the leveling agent, 0.2 to 5 parts by weight of the substrate wetting agent, 0.1 to 2 parts by weight of the dispersant, 2 to 10 parts by weight of the organic smoothing agent, 1 to 5 parts by weight of the thickener, 1 to 5 parts by weight of the matting agent, 2 to 10 parts by weight of the bridging agent, and 10 to 70 parts by weight of water.

The mixing step S102 is implemented by mixing the components in the preparation step S101.

The grinding step S103 is implemented by grinding the components that have been evenly mixed.

The filtering step S104 is implemented by filtering the components that have been grinded to get the water-based surface treatment agent 1.

It should be noted that the above steps are configured to provide a better water-based surface treatment agent 1, but the water-based surface treatment agent 1 is not limited to being produced by the above steps.

### Method for Implementing Water-Based Surface Treatment Agent

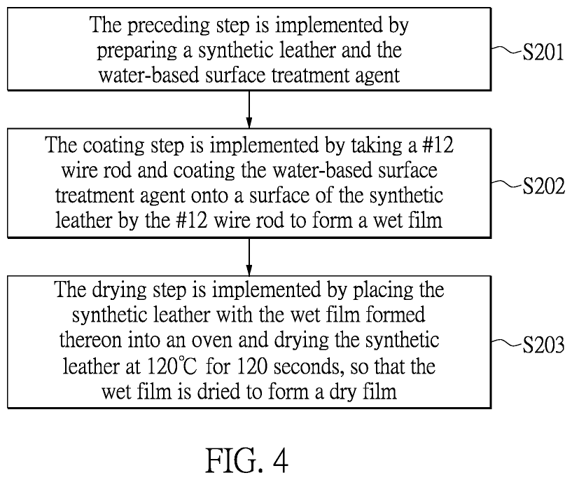

Referring to FIG. 4, FIG. 4 is a method for implementing the water-based surface treatment agent of the embodiment of the present disclosure. In the present embodiment, the water-based surface treatment agent 1 can be implemented by a preceding step S201, a coating step S202, and a drying step S203, but the present disclosure is not limited thereto.

The preceding step S201 is implemented by preparing a synthetic leather L and the water-based surface treatment agent 1.

The coating step S202 is implemented by taking a #12 wire rod and coating the water-based surface treatment agent 1 onto a surface S of the synthetic leather L by the #12 wire rod to form a wet film 1a.

The drying step S203 is implemented by placing the synthetic leather L with the wet film 1a formed thereon into an oven (not shown) and drying the synthetic leather L at 120° C. for 120 seconds, so that the wet film 1a is dried to form a dry film 1b.

It should be noted that in other embodiments, the water-based surface treatment agent 1 can further include a high boiling point film forming agent to facilitate a forming process of the dry film 1b, and based on 100 parts by weight of the water-based surface treatment agent 1, a content range of the high boiling point film forming agent is 1 to 5 parts by weight, but the present disclosure is not limited thereto.

### Experimental Results

Hereinafter, exemplary examples 1 to 5 and comparative examples 1 to 3 will be described in detail. However, the exemplary examples are only used to aid in understanding of the present disclosure, and the scope of the present disclosure is not limited to these examples.

The content range of the components, the scratch resistance, the abrasion resistance, the cold and tortuous resistance at low temperature, the crease whitening phenomenon over time, and the adhesion resistance of the water-based surface treatment agents 1 of exemplary examples 1 to 5 and comparative examples 1 to 3 are listed in Table. 1 as follows. The water-based surface treatment agents 1 of exemplary examples 1 to 5 and comparative examples 1 to 3 are coated on the surfaces S of a plurality of the synthetic leathers L to form a plurality of test pieces, and the testing methods of related properties of the test pieces are described as follows.

The abrasion resistance test includes: taking a test piece having a size about 25 mm*200 mm, placing the test piece in an abrasion resistance testing machine, using a dry cloth having about 200 grams load thereon to cause abrasion for 100 times, and observing whether or not the surface S coated with the water-based surface treatment agent 1 is worn off, damaged, or brightened.

The value of the abrasion resistance is determined according to an abrasion degree of the surface S coated with the water-based surface treatment agent 1. The value of the abrasion resistance is scored from 0 to 10, and the highest score is 10.

The scratch resistance test includes: taking a test piece having a size about 100 mm*100 mm, scratching the surface S coated with the water-based surface treatment agent 1, and observing a degree that the surface S is scratched.

The value of the scratching resistance is determined according to the degree that the surface S is scratched. The value of the scratching resistance is scored from 0 to 10 and the highest score is 10.

The cold and tortuous resistance at low temperature includes: taking a test piece having a size about 5 cm*5 cm, placing the test piece in a cold and tortuous resistance testing machine, and folding the test piece for 30,000 times at −10° C. to test the cold and tortuous resistance.

The value of the cold and tortuous resistance at low temperature is determined according to a degree that the surface S is broken. The value of the cold and tortuous resistance at low temperature is scored from 0 to 10, and the highest score is 10.

The crease whitening phenomenon over time test includes: taking a test piece having a size about 4 cm*15 cm, coating the water-based surface treatment agent 1 onto the surface S at a room temperature, folding the test piece inwards in half along a horizontal direction, adding about 3 kilograms load thereon, and after 24 hours, and taking the test piece and observing whether or not the crease of the surface S is whitened.

The value of the crease whitening with time is determined according to a degree that the surface S is whitened. The value of the crease whitening with time is scored from 0 to 10, and the highest score is 10.

The adhesion resistance test includes: taking two test pieces each having a size about 5 cm*5 cm, contacting the two surfaces S coated with the water-based surface treatment agent 1, adding about 3 kilograms load thereon, placing the two test pieces into a thermostatic container (not shown) having a temperature within a range from 68° C. to 72° C. for 24 hours, and taking out the test pieces to observe whether or not the surfaces S adhere to each other.

The value of the adhesion resistance is determined according to a degree that the surfaces S are adhered to each other. The value of the adhesion resistance is scored from 0 to 10, and the highest score is 10.

Table 1 shows the content of each component and test results of the exemplary and comparative examples.

| | | exemplary | exemplary | exemplary | exemplary | exemplary |
|---|---|---|---|---|---|---|
| | Items | example 1 | example 2 | example 3 | example 4 | example 5 |
| Parameter of each | content of waterborne | 20 | 20 | 30 | 30 | 30 |
| | polyurethane (wt %) | | | | | |
| | content of silicone | 10 | 20 | 5 | 15 | 20 |
| | powder (wt %) | | | | | |
| | content of antifoaming | 0.5 | 0.5 | 0.5 | 0.5 | 0.5 |
| | agent (wt %) | | | | | |
| | content of leveling | 1 | 1 | 1 | 1 | 1 |
| | agent (wt %) | | | | | |
| | content of substrate | 0.5 | 0.5 | 0.5 | 0.5 | 0.5 |
| | wetting agent (wt %) | | | | | |
| | content of dispersant | 0.2 | 0.2 | 0.2 | 0.2 | 0.2 |
| | (wt %) | | | | | |
| | content of organic | 5 | 10 | 5 | 10 | 15 |
| | smoothing agent (wt %) | | | | | |
| | content of thickener | 1 | 1 | 1 | 1 | 1 |
| | (wt %) | | | | | |
| | content of matting | 1 | 1 | 1 | 1 | 1 |
| | agent (wt %) | | | | | |
| | content of water (wt %) | 60.8 | 45.8 | 55.8 | 40.8 | 30.8 |
| Test results | abrasion resistance | 9 | 8 | 8 | 9 | 8 |
| | of water-based surface | | | | | |
| | treatment agent | | | | | |
| | scratch resistance of | 9 | 8 | 8 | 9 | 8 |
| | water-based surface | | | | | |
| | treatment agent | | | | | |
| | cold and tortuous | 9 | 9 | 9 | 9 | 9 |
| | resistance at low | | | | | |
| | temperature of | | | | | |
| | water-based surface | | | | | |
| | treatment agent | | | | | |
| | crease whitening | 8 | 8 | 9 | 9 | 8 |
| | phenomenon over | | | | | |
| | time of water-based | | | | | |
| | surface treatment | | | | | |
| | agent | | | | | |
| | adhesion resistance | 9 | 9 | 9 | 9 | 9 |
| | of water-based surface | | | | | |
| | treatment agent | | | | | |

| | | comparative | comparative | comparative |
|---|---|---|---|---|
| Items | | example 1 | example 2 | example 3 |
| Parameter of | content of waterborne | 20 | 20 | 20 |
| each component | polyurethane (wt %) | | | |
| | content of silicone | 0 | 0 | 25 |
| | powder (wt %) | | | |
| | content of antifoaming | 0.5 | 0.5 | 0.5 |
| | agent (wt %) | | | |
| | content of leveling | 1 | 1 | 1 |
| | agent (wt %) | | | |
| | content of substrate | 0.5 | 0.5 | 0.5 |
| | wetting agent (wt %) | | | |
| | content of dispersant | 0.2 | 0.2 | 0.2 |
| | (wt %) | | | |
| | content of organic | 10 | 0 | 10 |
| | smoothing agent (wt %) | | | |
| | content of thickener | 1 | 1 | 1 |
| | (wt %) | | | |
| | content of matting agent | 1 | 1 | 1 |
| | (wt %) | | | |
| | content of water (wt %) | 65.8 | 75.8 | 40.8 |
| Test results | abrasion resistance of | 6 | 5 | 6 |
| | water-based surface | | | |
| | treatment agent | | | |
| | scratch resistance of | 6 | 5 | 7 |
| | water-based surface | | | |
| | treatment agent | | | |
| | cold and tortuous | 6 | 5 | 5 |
| | resistance at low | | | |
| | temperature of water- | | | |
| | based surface treatment | | | |
| | agent | | | |
| | crease whitening | 6 | 6 | 5 |
| | phenomenon over | | | |
| | time of water-based | | | |
| | surface treatment agent | | | |
| | adhesion resistance of | 8 | 8 | 8 |
| | water-based surface | | | |
| | treatment agent | | | |

Discussion of Test Results

Since the silicone powder is added into the water-based surface treatment agents 1 of exemplary examples 1 to 5, the water-based surface treatment agents 1 can provide the better abrasion resistance, the scratch resistance, the cold and tortuous resistance at low temperature, the crease whitening phenomenon over time, and the adhesion resistance, compared to the water-based surface treatment agents 1 of comparative examples 1 and 2 without the silicone powder.

As shown in comparative example 3, although the silicone powder is added into the water-based surface treatment agent 1, the content of the silicone powder is too great. Therefore, the water-based surface treatment agent 1 of comparative example 3 cannot provide the abrasion resistance, the scratch resistance, the cold and tortuous resistance at low temperature, the crease whitening phenomenon over time, and the adhesion resistance as those in exemplary examples 1 to 5.

As shown in exemplary examples 1 to 5, the water-based surface treatment agent 1 of exemplary example 4 can provide better properties (e.g., better abrasion resistance, scratch resistance, and crease whitening phenomenon over time) compared to the water-based surface treatment agents 1 of exemplary examples 1 to 3 and exemplary example 5. Therefore, when the parameter of each component of the water-based surface treatment agent 1 is close to that of the water-based surface treatment agent 1 of exemplary example 4, the water-based surface treatment agent 1 can provide more ideal properties (i.e., the abrasion resistance, the scratch resistance, and the crease whitening phenomenon over time).

### Beneficial Effects of the Embodiments

In conclusion, since the water-based surface treatment agent includes 20 to 30 parts by weight of waterborne polyurethane, 3 to 30 parts by weight of silicone powder, the non-volatile matter content of the waterborne polyurethane is within a range from 20 wt % to 30 wt %, and each grain of the silicone powder has a particle size within a range from 0.2 μm to 15 μm, a specific gravity within a range from 0.9 to 1.5, a water content within a range from 0.1% to 0.5%, and a hardness (A) within a range from 30 to 90, pollution to the environment can be prevented, the abrasion resistance and the scratch resistance of the dry film formed by the water-based surface treatment agent can be enhanced, and other properties of the dry film are not negatively affected.

The water-based surface treatment agent does not include inorganic materials such as talcum powder or silicon dioxide or organic materials such as wax or stearic acid. Therefore, an issue about the conventional surface treatment agent can be improved. (i.e., the conventional surface treatment agent includes the above inorganic materials or organic materials to improve the abrasion resistance and the scratch resistance, but the inorganic materials or the organic materials affect other properties of the dry film, such as the cold and tortuous resistance at low temperature, the crease whitening phenomenon over time, the adhesion resistance, and the gloss).

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A water-based surface treatment agent, suitable to be coated onto a surface of a synthetic leather, the water-based surface treatment agent comprising:
waterborne polyurethane;
silicone powder; and
water;
wherein, based on 100 parts by weight of the water-based surface treatment agent, a content range of the waterborne polyurethane is 15 to 35 parts by weight, and a content range of the silicone powder is 3 to 20 parts by weight,
wherein a non-volatile matter content of the waterborne polyurethane is within a range from 20 wt % to 30 wt %, and wherein each grain of the silicone powder has a particle size within a range from 0.2 um to 15 um, a specific gravity within a range from 0.9 to 1.5, a water content within a range from 0.1% to 0.5%, and a hardness (A) within a range from 30 to 90.

2. The water-based surface treatment agent according to claim 1, wherein the water-based surface treatment agent does not have any volatile organic compounds (VOC).

3. The water-based surface treatment agent according to claim 1, wherein the waterborne polyurethane is at least one selected from the group consisting of waterborne flat polyurethane, waterborne matting polyurethane, and waterborne self-matting polyurethane.

4. The water-based surface treatment agent according to claim 1, wherein the silicone powder is at least one selected from the group consisting of silicone composite powder, silicone rubber powder, and silicone resin powder, and wherein, based on 100 parts by weight of the water-based surface treatment agent, the content range of the silicone powder is 6 to 13 parts by weight.

5. The water-based surface treatment agent according to claim 1, further comprising an antifoaming agent, a leveling agent, a substrate wetting agent, a dispersant, an organic smoothing agent, a thickener, a matting agent, and a bridging agent, wherein, based on 100 parts by weight of the water-based surface treatment agent, a content range of the antifoaming agent is 0.2 to 2 parts by weight, a content range of the leveling agent is 0.2 to 5 parts by weight, a content range of the substrate wetting agent is 0.2 to 5 parts by weight, a content range of the dispersant is 0.1 to 2 parts by weight, a content range of the organic smoothing agent is 2 to 10 parts by weight, a content range of the thickener is 1 to 5 parts by weight, a content range of the matting agent is 1 to 5 parts by weight, a content range of the bridging agent is 2 to 10 parts by weight, and a content range of water is 10 to 70 parts by weight.

6. The water-based surface treatment agent according to claim 5, wherein the leveling agent is at least one selected from the group consisting of acrylic copolymer and organosilicon compound.

7. The water-based surface treatment agent according to claim 5, wherein the antifoaming agent is at least one selected from the group consisting of emulsified silicone oil, higher alcohol fatty acid ester complex, polyoxyethylene polyoxypropylene pentaerythritol ether, polyoxyethylene polyoxypropyle, polyoxypropylene glycerol ether, and polyoxypropylene.

8. The water-based surface treatment agent according to claim 5, wherein the substrate wetting agent is at least one selected from the group consisting of polyoxyethylene alkylphenol ether, polyoxyethylene fatty alcohol ether, polyoxyethylene polyoxypropylene block copolymer, and silanol non-ionic surfactant.

9. The water-based surface treatment agent according to claim 5, wherein the dispersant is at least one selected from the group consisting of acrylic dispersant, modified acrylic dispersant, and modified block polymer.

10. The water-based surface treatment agent according to claim 5, wherein the organic smoothing agent is at least one selected from the group consisting of polydialkylsiloxane, modified polysiloxane, branched polyorganosiloxane, polyolefin wax, polyamide wax, polytetrafluoroethene (PTFE), and perfluoroalkoxy resin (PFA).

11. The water-based surface treatment agent according to claim 5, wherein the thickener is at least one selected from the group consisting of polyacrylic acid thickener and polyurethane associative thickener.

12. The water-based surface treatment agent according to claim 5, wherein the bridging agent is an urea-formaldehyde resin crosslinking agent and is at least one selected from the group consisting of oxazoline, polycarbodiimide, polyisocyanate, blocked isocyanate, polysiloxane, aziridine, and alkylated melamine
